(19) United States
(12) Patent Application Publication
(10) Pub. No.: US 2024/0029533 A1
(43) Pub. Date: Jan. 25, 2024

(54) PROVIDING SMART ALARM INFORMATION IN A COMPUTING SYSTEM USING DETECTED ALARMS

(71) Applicant: VMware, Inc., Palo Alto, CA (US)

(72) Inventors: Minjal AGARWAL, San Jose, CA (US); David TSAI, Palo Alto, CA (US); Sonam SINHA, San Jose, CA (US)

(21) Appl. No.: 17/813,455

(22) Filed: Jul. 19, 2022

(51) Int. Cl. G08B 19/00

(52) U.S. Cl. CPC G08B 19/00

(57) ABSTRACT

The disclosure herein describes managing smart alarms based on an associated set of alarms and/or events. The alarms are detected in a computing system and the detected alarms are used to identify a smart alarm definition with which the detected alarms are associated. A condition of the identified smart alarm definition is evaluated, and it is determined that the condition is satisfied at least in part by the set of alarms. Smart alarm information is then provided using the smart alarm definition and the detected set of alarms. Providing smart alarm information associated with the detected set of alarms and/or events provides additional context to enable efficient interpretation of detected alarms in a computing system. Further, managing the smart alarms as described reduces the quantity of individual alarms that must be processed and reduces the likelihood of errors occurring as those alarms are processed.

### BACKGROUND

In modern computing systems, many computing events that occur trigger alarms that are recorded or displayed to enable users, administrators, and/or other entities to monitor the associated computing system. However, such alarms and the associated events that trigger them are unidimensional, do not indicate whether they are related to other alarms or events, and/or do not provide any other context information. The large quantities of such alarms in complex, distributed computing systems present significant challenges at least in that it is computationally-intensive to repeatedly trigger alarms, and labor-intensive to effectively review the triggered alarms. This can negatively impact the performance of the computing system.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A computerized method for managing smart alarms based on an associated set of alarms and/or events is described. The alarms and/or associated events are detected in a computing system and the detected alarms and/or events are used to identify a smart alarm definition with which the detected alarms and/or events are associated. A condition of the identified smart alarm definition is evaluated, and it is determined that the condition is satisfied at least in part by the set of alarms and/or events. Smart alarm information is then provided using the smart alarm definition and the detected set of alarms and/or events.

### BRIEF DESCRIPTION OF THE DRAWINGS

The present description will be better understood from the following detailed description read in light of the accompanying drawings, wherein:

FIG. 1 is a block diagram illustrating a system configured to manage smart alarms based on detected alarms in a computing system;

FIG. 2 is a flowchart illustrating a method for managing smart alarms based on detected alarms in a computing system;

FIG. 3 is a flowchart illustrating a method for providing smart alarm information and/or alarm information based on a plurality of alarms and/or events in a computing system;

FIG. 4 is a diagram illustrating a Graphical User Interface (GUI) configured to display smart alarm information;

FIG. 5 is a diagram illustrating a GUI configured to enable a user to create and/or edit smart alarm definitions; and

FIG. 6 illustrates an example computing apparatus as a functional block diagram.

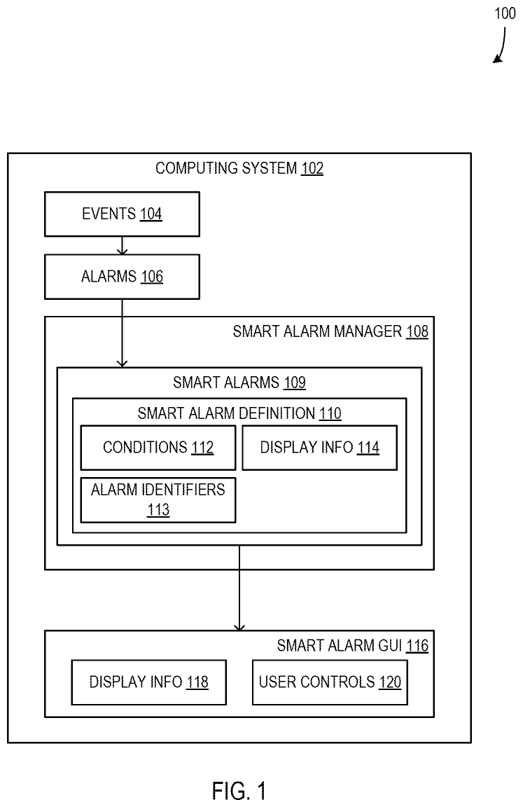

Corresponding reference characters indicate corresponding parts throughout the drawings. In FIGS. 1 to 6, the systems are illustrated as schematic drawings. The drawings may not be to scale.

### DETAILED DESCRIPTION

Aspects of the disclosure provide a computerized method and system for managing smart alarms and providing smart alarm information based on detected sets of alarms and/or events. The disclosure describes the detection of alarms and/or events in a computing system. The detected alarms and/or events are used to identify smart alarm definitions. The conditions of those identified smart alarm definitions are evaluated using the detected alarms and/or events. When the conditions of a smart alarm definition are satisfied, the smart alarm is triggered, and smart alarm information is provided based on the smart alarm definition and the detected alarms and/or events. In many examples, a smart alarm is triggered based on the occurrence of a plurality of alarms and/or events, such that the smart alarm reflects a relationship between the plurality of alarms and/or events. For example, a computing device rebooting event triggers a plurality of alarms, and a smart alarm definition associated with the rebooting event is defined to be triggered by the occurrence of the plurality of alarms within a particular time interval.

The disclosure operates in an unconventional manner at least by enabling the definition of smart alarms based on the occurrence of existing events and/or alarms in the computing system. Smart alarms defined in this way provide a flexible way to provide and/or record additional contextual information about events on the computing system. Further, by defining smart alarms to fit common patterns of events and/or alarms on a computing system, the disclosure enables the recording of alarms within the computing system to be done in a more organized and efficient way (e.g., alarms that would otherwise be recorded separately are grouped into recorded smart alarm information). In some examples, this results in more efficient use of alarm log storage space in a system, as well as enabling more efficient analysis of recorded alarm information and reducing wasted use of processing and/or memory resources during analysis of recorded alarm information.

Further, in examples where smart alarm information is provided to a user or other entity in real time or near real time, the disclosure enables such an entity to quickly and efficiently respond to issues that are indicated by triggered smart alarms. Because such responses are likely to happen more quickly than in systems that do not use the described smart alarms, wasteful or otherwise harmful behavior on such systems can be addressed more quickly as well, thereby improving the efficiency with which processing and/or memory resources of a computing system can be used over time.

The disclosure provides further flexibility in monitoring system operations by enabling the use of smart alarms that are triggered by alarms, events, current metric values, time series of metric values, or some combination thereof. By providing users with the ability to automatically determine the sets of system states should trigger smart alarms, the users are enabled to reduce the total quantity of alarms and/or events that must be reviewed, as smart alarms can be defined to not be triggered when they would be extraneous based on certain conditions in the computing system. For example, a bandwidth usage-based smart alarm is only triggered when bandwidth usage is high but processor usage is low, representing a state in which the system is “wasting” bandwidth.

The disclosure enables the definition of smart alarms that can be used to track the occurrence of events that trigger many different alarms. In some examples, these causation-based smart alarms provide users that analyze system alarms with useful context information for a set of alarms that they would have otherwise had to have derived manually from reviewing the occurrence of individual alarms.

Additionally, the disclosure provides user interfaces, including graphical user interfaces (GUIs), which enable users to view the provided smart alarm information and to create, edit, and/or delete smart alarm definitions on a computing system in a user-friendly way. Such GUIs improve the rate at which a user can act in response to the triggering of a smart alarm to correct any related issues, thereby reducing the time that the performance of the computing system is impacted by those issues. This further improves the overall efficiency with which the computing system makes use of its processing, memory and/or data storage resources.

FIG. 1 is a block diagram illustrating a system 100 configured to manage smart alarms 109 based on detected alarms 106 in a computing system 102. In some examples, events 104 that occur in the computing system 102 trigger alarms 106. Those triggered alarms 106 are detected by the smart alarm manager 108, which then identifies smart alarms 109 associated with the detected alarms 106. Smart alarm definitions 110 associated with the smart alarms 109 are used to determine whether the associated smart alarms 109 should be triggered. If a smart alarm 109 is triggered, the smart alarm manager 108 provides information about the triggered smart alarm 109, such as display information 114, to a smart alarm graphical user interface (GUI) 116 and/or to other smart alarm destination entities (e.g., a log that records triggered smart alarm information).

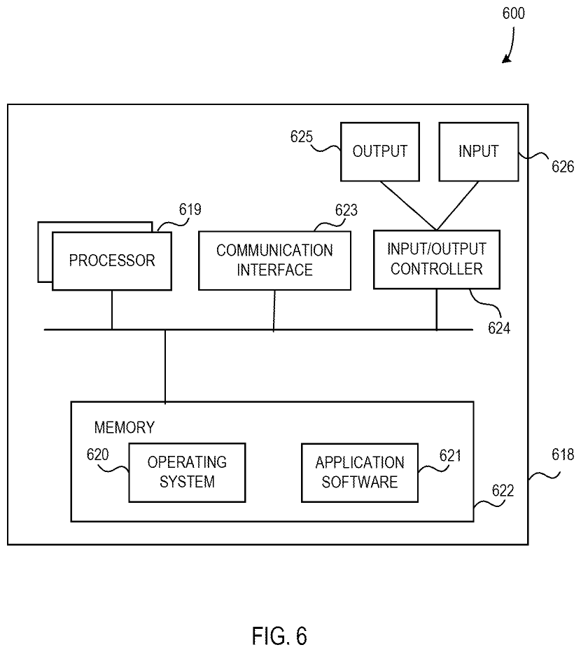

In some examples, the computing system 102 includes a computing device (e.g., the computing apparatus of FIG. 6). Further, in some examples, the computing system 102 includes multiple computing devices that are configured to communicate with each other via one or more communication networks (e.g., an intranet, the Internet, a cellular network, other wireless network, other wired network, or the like). Additionally, or alternatively, the computing system 102 includes one or more virtual computing instances (VCIs), such as virtual machines (VMs), containers, or the like, which are executed on one or more computing devices of the computing system 102. In some such examples, the events 104 that occur in the computing system 102 occur on one or more computing devices of the computing system 102 and/or on one or more VCIs of the computing system 102 without departing from the description. Further, in some such examples, the smart alarm manager 108 is configured to be located on and/or executed on one or more of the computing devices of the computing system 102 and/or one or more of the VCIs of the computing system 102 without departing from the description. For example, a smart alarm manager 108 is stored on and executed on a first computing device of the computing system, an event 104 on a second computing device of the computing system 102 triggers an alarm 106 in the computing system 102, and the smart alarm manager 108 on the first computing device detects the triggered alarm 106.

Further, in some examples, the events 104 include a wide variety of events that occur on the computing system 102 as it executes and/or otherwise performs operations, program code, applications, or the like. Events 104 can be triggered by hardware, firmware, and/or software of the computing system 102. For instance, an event 104 occurs on a computing device of the computing system 102 when a file is created, changed, or deleted; when a memory state is changed; when a network connection is formed or interrupted; when information is received over a network connection; when a hardware-level event occurs; or the like. In other examples, more, fewer, or different types of computing events within a computing devices are included in described events 104 without departing from the description.

Alarms 106 are triggered by the occurrence of events 104. In some examples, alarms 106 are defined to be triggered based on the occurrence of one or more events 104 in the computing system 102. The computing system 102 is configured using such an alarm definition to detect the occurrence of an event or events 104 and then trigger the associated alarm 106, which is provided to a user by an interface, recorded in a log associated with triggered alarms, or the like. In such examples, the alarms 106 are defined to be triggered to notify a user or other entity of the occurrence of a particular event or events within the computing system 102 such that action can be taken in response to the event or events and/or behavior of the computing system 102 can be analyzed or reviewed with respect to the event or events. In an example, an alarm 106 is triggered when a computing device within the computing system 102 uses greater than 90% of its available network bandwidth for more than one minute. The computing system 102 monitors the bandwidth usage of the computing device over time and the use of 90% or more of available network bandwidth for one minute or more constitutes an event 104 for which an alarm 106 is triggered. In some such examples, the alarm 106 is received by a user and it enables the user to take action in response to the high usage of network bandwidth (e.g., the user can reconfigure the traffic of the computing device to be split over multiple computing devices of the computing system 102 to avoid the computing device becoming a bottleneck that reduces efficiency of the computing system 102). Additionally, or alternatively, the high bandwidth usage alarm 106 is logged and later, the data associated with when the alarm 106 is triggered is analyzed to determine whether further action is needed to correct or enhance behavior of the computing system 102.

Further, in some examples, alarms 106 are configured to be activated (e.g., opened) and deactivated (e.g., closed). In such examples, the occurrence of the event 104 triggers an alarm 106 to be activated and it remains activated until something causes it to become deactivated (e.g., another event 104, a condition of the alarm 106 being no longer satisfied, a user selecting to deactivate the alarm 106 via an interface, an amount of time passing since activation, or the like). Further, in some such examples, smart alarms 109 that are triggered based on alarms 106 as described herein are triggered based on those alarms 106 being activated, such that smart alarms 109 dependent on an alarm 106 can be triggered at any time during which the alarm 106 is activated.

In many examples, many alarms 106 are configured to trigger based on low-level events 104 and/or application-specific events 104 that are agnostic to the context or cause of the events 104. In an example, if an edge device of the computing system 102 is rebooted, many different alarms 106 are triggered based on different entities within the computing system 102 that relied on the edge device detecting that it became unavailable while rebooting. For example, some devices and/or VCIs of the computing system 102 were using the edge device for a network connection to another entity outside of the computing system 102 and, when the edge device goes offline during reboot, those network connections are interrupted. In such an example, those other entities trigger alarms 106 that indicate a loss of use of the edge device upon which they rely, but in existing systems those alarms 106 often do not indicate that the edge device is being rebooted. With existing systems, users must review the set of various alarms 106 that occurred and then infer that they all occurred because the edge device was rebooted.

It should be understood that, in some examples, events 104 occur on a computing system for a wide variety of reasons and they are logged somewhere on the system or otherwise detectable. Alarms 106 are triggered based on events 104, such that alarms 106 are a level of abstraction above the events 104. Alarms 106 are triggered to become active, or open, as described herein based on the occurrence of one or more events 104 and they remain active or open until they are deactivated or closed. Alarms 106 are configured to notify a user or other entity that the one or more events have occurred. The smart alarms 109 described herein are a level of abstraction above the alarms 106 in that they are configured to detect a pattern of alarms 106 and/or events 104 and then notify an entity that the pattern of alarms 106 and/or events 104 and provide associated context information.

However, in the system 102, the smart alarm manager 108 is configured to detect the alarms 106 and determine whether a smart alarm 109 should be triggered. In some examples, the smart alarms 109 are configured to provide enhanced alarm information about triggered alarms, including context information and/or cause information about groups of alarms 106 that occur throughout the computing system 102 based on the same or similar events 104. In the above example of the edge device being rebooted, the smart alarm manager 108 is configured to detect the alarms 106 triggered during the rebooting process, compare the detected alarms 106 to a smart alarm definition 110 of a smart alarm 109 that is associated with edge devices rebooting, determine that the detected alarms 106 are all likely the result of the edge device rebooting, and then provide smart alarm display information 114 and/or other associated information to a smart alarm GUI 116 for display to a user and/or to other alarm information targets in the computing system 102. The display information 114 of the triggered smart alarm 109 includes an indication that an edge device was rebooted, an identifier of the edge device that was rebooted, and/or a list of alarms 106 that were triggered based on the edge device being rebooted. This functionality provides useful context to a user that is reviewing alarms that occur on the computing system 102 and cuts down on the noise associated with large quantities of alarms 106 being provided with little or no context information.

Smart alarms 109 are defined using smart alarm definitions 110. In some examples, a smart alarm definition 110 includes the conditions 112 that must be satisfied to trigger the smart alarm 109, alarm identifiers 113 of alarms 106 that may trigger the smart alarm 109 based on the conditions 112, and/or display information 114 that is displayed and/or recorded when the smart alarm 109 is triggered. In some examples, the conditions 112 include a condition that is defined based on an event that is known to trigger a known plurality of alarms 106. For instance, in the example above, an edge device being rebooted is known to trigger multiple alarms 106 that indicate that operations of various other entities of the computing system 102 that use the edge device have been interrupted. Such a smart alarm 109 is a “causation” smart alarm because the occurrence of multiple events 104 and triggering of the associated alarms 106 are effectively combined due to all be based on the same cause (e.g., the rebooting of the edge device).

Further, in some examples, the conditions 112 include a condition that is defined based on the occurrence of multiple events 104 and/or associated alarms 106 that are evaluated together. For example, a smart alarm 109 is defined to be triggered based on a condition 112 that includes a central processing unit (CPU) usage of above 80% for 15 minutes and network traffic that is lower than 100 kilobytes per second (KB/s). In this example, determining whether to trigger the smart alarm 109 includes evaluating the CPU usage metrics of the computing system 102 and/or a computing device therein and the network traffic metrics of the computing system 102 and/or a computing device therein. Then, the smart alarm 109 is only triggered when both conditions 112 are true because they are combined using an ‘and’ Boolean operator. In other examples, other Boolean operators, such as ‘or’, are used to combine multiple conditions 112 that trigger a smart alarm 109. In another example, a smart alarm 109 is triggered based on the satisfaction of: (Condition A and Condition B) or (Condition C and Condition D). In this example, the smart alarm 109 is triggered when condition A and condition B are true, or when condition C and condition D are true. It is also triggered when all four conditions are true. In other examples, other operators, such as ‘not’, ‘exclusive or’, or the like are used without departing from the description.

Still further, in some examples, the conditions 112 include a condition that is defined based on correlation of multiple events 104 and associated alarms 106 that lead to an event associated with the smart alarm 109. For example, alarms 106 are triggered that indicate a computing device A cannot reach a computing device B and that a computing device C cannot reach computing device B. These two alarms 106 are used to trigger a smart alarm 109 that indicates that computing device B is unreachable, based on a smart alarm definition. This smart alarm 109 display information 114 further includes identifiers of the two alarms 106 that triggered the smart alarm 109. In some such examples, these smart alarms 109 are considered “parent alarms” to the “child alarms” 106 that are used to trigger them. Further, in some examples, these smart alarms 109 are only triggered when all associated child alarms 106 are triggered.

It should be understood that, while many of the examples described herein include smart alarms 109 being triggered by other alarms 106, in other examples, smart alarms 109 are triggered by one or more events 104 that are otherwise not associated with alarms 106. For example, a smart alarm 109 is configured to be triggered based on a high CPU usage metric, but only when the high CPU usage metric impacts operations of the system, leading to drop. In this example, the smart alarm 109 may be triggered based on detecting a drop-based alarm and detecting a high CPU usage metric event over the same time period. In another example, a smart alarm 109 is configured to be triggered when the memory pool usage level is high, but not when it is high because of a network traffic spike. For example, the smart alarm 109 may be triggered when the memory pool usage level metric meets a first condition threshold and when the network traffic metric is below a second condition threshold. Further, in some such examples, a smart alarm 109 is triggered by at least one alarm 106 being triggered and by at least one event 104 occurring that is otherwise not associated with an alarm 106. Additionally, or alternatively, events 104 and/or alarms 106 can contribute to triggering more than one smart alarm 109 without departing from the description.

In some examples, the conditions 112 of a smart alarm definition 110 are tied to alarm identifiers 113. In such examples, the conditions 112 require some or all of the alarm identifiers 113 to be detected for the associated smart alarm 109 to be triggered. Further, in some examples, the alarm identifiers 113 identify the type of alarms 106 that are detected but not necessarily the specific alarms 106 detected. For instance, an alarm identifier 113 identifies an alarm 106 that indicates loss of a network connection, but the alarm identifier 113 does not identify an alarm 106 that indicates the loss of a network connection by a specific VCI of the computing system 102. Additionally, or alternatively, the conditions 112 of such a smart alarm definition 110 are satisfied when alarms 106 that match all of the alarm identifiers 113 are detected and/or when alarms 106 that match at least a defined quantity and/or percentage of the alarm identifiers 113 are detected. For example, an alarm 109 may be triggered when 70% of the alarm identifiers 113 of the smart alarm definition 110 are present in the detected alarms 106.

The display information 114, or display info 114, includes information that is used to identify the smart alarm 109 and/or to provide a description or context of the smart alarm 109. In some examples, the display info 114 includes a generic name and/or description of the smart alarm 109 (e.g., “Edge Device Reboot Alarm”). Further, in some examples, the display info 114 includes fields where specific information about the current smart alarm 109 instance is provided, such as timestamp information, computing devices or VCIs that are associated with the smart alarm 109 instance, specific alarms 106 that contributed to the smart alarm 109 instance being triggered, or the like.

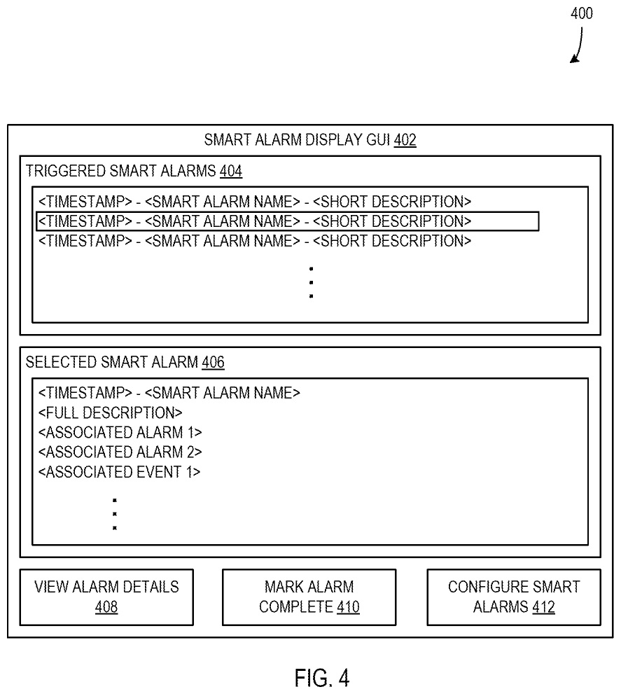

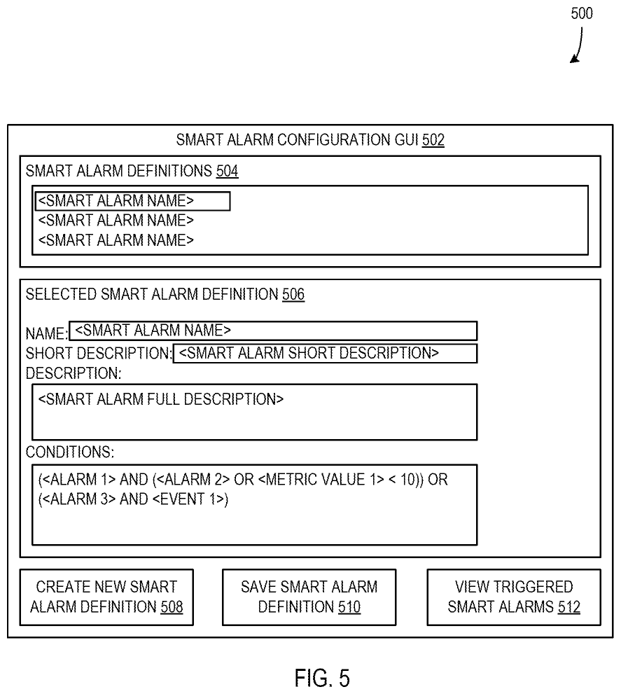

In some examples, the display info 114 of the smart alarm definition 110 is provided to a smart alarm GUI 116 upon the associated smart alarm 109 being triggered, wherein the provided display info 114 is displayed on the GUI 116 as display info 118. The display info 118 and the GUI 116 are described in greater detail below with respect to FIGS. 4 and 5. Additionally, or alternatively, the GUI 116 includes user controls 120 that are configured to enable a user to create a smart alarm definition 110 of a smart alarm 109, to edit a smart alarm definition 110, and/or to delete a smart alarm definition 110. These user activities using the GUI 116 are described in greater detail herein, such as with respect to FIGS. 4 and 5.

It should be understood that, while the smart alarm GUI 116 and smart alarm manager 108 are illustrated as part of the computing system 102, in other examples, the GUI 116 and/or the manager 108 are stored on and/or executed on one or more computing devices that are outside the computing system 102 without departing from the description. In such examples, the smart alarms 109 are managed and/or displayed on the GUI 116 based on alarms 106 and/or events 104 occurring on the computing system 102.

In some examples, the smart alarm definitions 110 of smart alarms 109 are configured and/or defined manually by users. Users may analyze the operations of the computing system 102 to identify events or other system states for which smart alarms 109 would be helpful. The computing system 102 is configured to enable a user to define conditions 112 associated with the identified events or system states such that a smart alarm 109 is triggered based on the occurrence of the identified events or system states. Further, the computing system 102 is configured to enable a user to define display information 114 that should be displayed when the associated smart alarm 109 is triggered. In an example where the computing system 102 includes a plurality of computing devices that are connected via network connections, a smart alarm definition 110 of a smart alarm 109 is configured to detect when a defined quantity of computing devices determine that a target computing device is unavailable and, as a result of the quantity of computing devices detecting that the target computing device is unavailable, a smart alarm 109 is triggered and display information 114 is provided that describes the state of the target computing device and/or indicates that the target computing device is unavailable.

Additionally, or alternatively, the computing system 102 is configured to collect data during operation and based at least in part on the collected data, to automatically identify sets and/or patterns of alarms 106 and/or events 104 that are used to generate smart alarm definitions 110. For instance, the computing system 102 is configured to identify a set of alarms that tend to occur contemporaneously in the computing system 102 and a smart alarm definition 110 of a smart alarm 109 is generated that includes conditions 112 that are satisfied by the identified set of alarms. Further, the generated smart alarm definition 110 is then included in the smart alarm manager 108 for use as described herein and/or the generated smart alarm definition 110 is provided to a user of the computing system 102 as a suggested smart alarm definition 110. The user is then enabled to accept or reject the suggested smart alarm definition 110 and, if it is accepted, the user is enabled to edit and/or complete the generated smart alarm definition 110 (e.g., adding to or editing display information 114 of the smart alarm definition 110).

Additionally, or alternatively, in some examples where suggested smart alarm definitions 110 are automatically generated by the computing system 102, the computing system 102 is configured to identify sets or patterns of alarms 106 and/or events 104 using machine learning techniques. In some examples, the computing system 102 includes a trained model (e.g., a neural network model) that has been trained to identify and/or classify sets of alarms 106 and/or events 104 as candidates for triggering a suggested smart alarm 109. Additionally, or alternatively, the computing system 102 includes a model that is trained to automatically determine context or descriptive information associated identified or classified sets of alarms 106 and/or events 104. In other examples, other types of machine learning techniques are used in the computing system 102 without departing from the description.

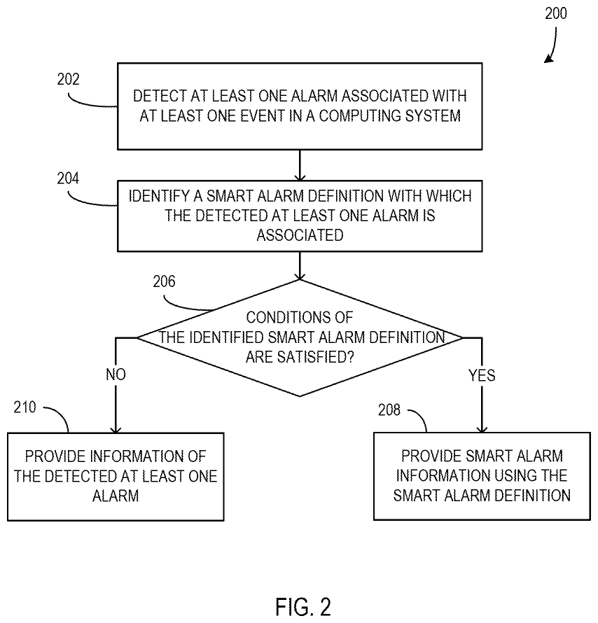

FIG. 2 is a flowchart illustrating a method 200 for managing smart alarms based on detected alarms in a computing system. In some examples, the method 200 is executed or otherwise performed in a system such as system 100 of FIG. 1. At 202, at least one alarm (e.g., alarms 106) associated with at least one event (e.g., events 104) is detected in a computing system (e.g., computing system 102). In some examples, the alarms are detected by a smart alarm manger (e.g., smart alarm manager 108) of the computing system. The computing system may be configured to send notifications of triggered alarms to the smart alarm manager, including information about the alarms and/or about the events that triggered the alarms. Additionally, or alternatively, the smart alarm manager is configured to request information about triggered or active alarms from the computing system periodically and/or based on the request for information being triggered in some other way (e.g., the smart alarm manager requests alarm information every two seconds and/or the smart alarm manager requests alarm information based at least in part on completing the management of a current set of smart alarms).

At 204, a smart alarm definition (e.g., smart alarm definition 110) that is associated with the detected at least one alarm is identified. In some examples, the smart alarm definition is identified based on comparing information about the detected alarm(s) with the conditions and/or alarm identifiers of the smart alarm definition and, upon determining that the detected alarm(s) sufficiently match the smart alarm definition, the smart alarm definition is identified. In an example, the smart alarm definition includes alarm identifiers of a first type and a second type. The detected alarms include an alarm of the first type and an alarm of the second type that occurred within a defined time period. Because the detected alarms include the types of alarms of the smart alarm definition, the smart alarm definition is identified as a smart alarm definition associated with the detected alarms. In such examples, the displaying, recording, and/or otherwise processing of data associated with the detected alarms is done based on the smart alarm definition rather than based on the information of the detected alarms separately.

In some examples, the detected alarms are known to be caused at least in part by an event of a particular type. The identified smart alarm definition may be defined to be associated with events of that type, such that the smart alarm of the smart alarm definition is triggered when the occurrence of an event of that type is detected via the detected alarms.

Further, in some examples, the smart alarm definition is identified based on metric values of various aspects of the computing system in addition to the detected alarms. As an example, if an alarm is detected associated with the operation of a processor of the computing system and a temperature metric value of the processor is found to exceed a defined threshold, this results in a particular smart alarm definition associated with processor temperature being identified. Additionally, or alternatively, in other examples, smart alarm definitions are identified based on detected alarms in other ways without departing from the description.

At 206, if the conditions of the identified smart alarm definition are satisfied, the process proceeds to 208. Alternatively, if the conditions of the identified smart alarm definition are not satisfied, the process proceeds to 210. In some examples, the conditions of the smart alarm definition are satisfied when the detected alarms include at least a portion the alarm types of the smart alarm definition. Additionally, or alternatively, the conditions of the smart alarm definition are satisfied based on evaluation of one or more conditions that are combined using Boolean operators or the like, wherein those conditions include the presence of detected alarms, metric values of the computing system meeting defined thresholds and/or value ranges, presence of detected events that are not otherwise associated with alarms, or the like.

At 208, smart alarm information is provided using the smart alarm definition (e.g., the display information 114 of the smart alarm definition 110). In some examples, providing the smart alarm information includes displaying the smart alarm information on a GUI to a user, as described below with respect to FIGS. 4 and 5. Additionally, or alternatively, providing the smart alarm information includes recording the smart alarm information in a log associated with events and/or alarms of the computing system. In some examples, the provided smart alarm information includes descriptive information and/or contextual information of the smart alarm and/or alarm information of the detected alarms with which the smart alarm is associated.

At 210, information of the detected at least one alarm is provided. In some examples, this includes providing alarm information for each detected alarm separately in a conventional manner.

Further, in some examples, a GUI is displayed that enables a user to create, edit, reconfigure, and/or delete smart alarm definitions. When smart alarm information is displayed to a user via a GUI at 208, the user is enabled to make changes to the smart alarm definition associated with the information being displayed through the use of user controls displayed on the GUI. Alternatively, the user is enabled to switch to another GUI that includes user controls for making changes to smart alarm definitions, creating new smart alarm definitions, and/or deleting smart alarm definitions.

Additionally, or alternatively, a user of the GUI displaying the smart alarm information is enabled to make changes to how the smart alarm information is displayed. In some examples, the changes made to how the information is displayed are recorded as part of the smart alarm definition, such that the changes are reflected when the smart alarm information is displayed to all users. Alternatively, in other examples, the changes made by the user are associated with a user profile that is specific to that user, such that changes made with respect to how smart alarm information is displayed are reflected when smart alarm information is being displayed in association with the user profile in the future.

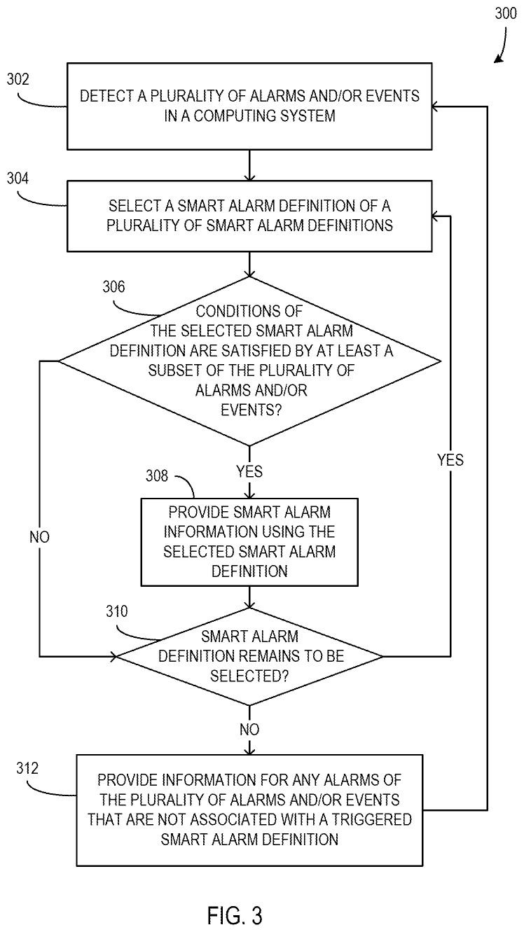

FIG. 3 is a flowchart illustrating a method 300 for providing smart alarm information and/or alarm information based on a plurality of alarms and/or events in a computing system. In some examples, the method 300 is executed or otherwise performed in a system such as system 100 of FIG. 1. In many computing systems, many alarms and/or other events are occurring frequently throughout the operation of the computing system. The method 300 is configured to manage a plurality of detected alarms and/or other events that are associated with one or more smart alarm definitions in some cases and not associated with any smart alarms in other cases.

At 302, a plurality of alarms and/or events are detected in a computing system. In some examples, the alarms are detected in substantially the same way as described above with respect to 202 of FIG. 2. Additionally, or alternatively, events of the computing system are detected that are otherwise not associated with alarms and/or that do not trigger other conventional alarms. For example, a smart alarm manager 108 is configured to monitor the computing system 102 to detect the occurrence of metric values of the system that meet or exceed defined thresholds or ranges, or the like. Such metric monitoring enables the smart alarm manager 108 to trigger smart alarms based on occurrences in the system that are not otherwise associated with alarms, as described herein.

At 304, a smart alarm definition is selected from a plurality of smart alarm definitions. In some examples, the plurality of smart alarm definitions includes all smart alarm definitions associated with the computing system, such that the method 300 evaluates all smart alarm definitions to determine whether they are triggered by the detected alarms and/or events.

At 306, if the conditions of the selected smart alarm definition are satisfied by at least a subset of the plurality of alarms and/or events, the process proceeds to 308. Alternatively, if the conditions of the selected smart alarm definition are not satisfied, the process proceeds to 310.

At 308, smart alarm information is provided based at least in part on the selected smart alarm definition. In some examples, providing the smart alarm information is performed in substantially the same way as described above with respect to 208 of FIG. 2. Additionally, in some examples, providing the smart alarm information includes displaying the smart alarm information on GUI as described below with respect to FIGS. 4 and 5.

At 310, if any smart alarm definitions remain to be selected, the process returns to 304 to select another smart alarm definition to be evaluated. Alternatively, if no smart alarm definitions remain to be selected, the process proceeds to 312.

At 312, information for any alarms of the plurality of alarms that are not associated with a triggered smart alarm definition is provided. In some examples, providing alarm information associated with alarms that are not associated with smart alarm definitions includes providing alarm information in a conventional manner (e.g., displaying and/or logging alarm information for each alarm separately).

In some examples, because each smart alarm definition is evaluated with respect to the detected plurality of alarms and/or events, a particular alarm and/or event is used to satisfy the conditions of multiple smart alarm definitions. Smart alarm definitions can be defined such that they have overlapping triggers with other smart alarm definitions, enabling high levels of flexibility in how a set of smart alarms are designed to be triggered in a computing system.

FIG. 4 is a diagram 400 illustrating a GUI 402 configured to display smart alarm information. In some examples, the GUI 402 is displayed by or in association with a system such as the system 100 of FIG. 1. Further, in some such examples, the GUI 402 is part of or includes a smart alarm GUI 116 as described above with respect to the system 100 of FIG. 1.

In some examples, the smart alarm display GUI 402 is configured to display information about smart alarms that have been triggered recently. The GUI 402 includes a triggered smart alarms section 404 and a selected smart alarm section 406. The triggered smart alarms section 404 displays a list of triggered smart alarms and enables a user of the GUI 402 to select one of the listed smart alarms to view more detail. In some examples, the triggered smart alarms section 404 is configured to be updated as smart alarms of the associated system are triggered. Further, the section 404 is configured to display the triggered smart alarms in an order based on the timestamp associated with the alarms' occurrence. Additionally, or alternatively, the section 404 is configured to enable a user to select how the listed smart alarms are displayed (e.g., sorting by smart alarm name instead of timestamp).

Further, as illustrated, the section 404 is configured to display information about each triggered smart alarm, including a timestamp that indicates when the smart alarm was triggered, a smart alarm name, and a short description of the smart alarm. In other examples, more, fewer, or different types of information are displayed in the section 404 without departing from the description. In some examples, the smart alarm name is a generic name of the associated smart alarm (e.g., a “computing device reboot” smart alarm) and more specific information is provided in the short description (e.g., a device identifier of the computing device that is rebooting and triggered the smart alarm). Additionally, or alternatively, the short description includes more or different information about the triggered smart alarm, such as a time at which the smart alarm must be addressed, a severity level associated with the smart alarm, or the like.

In some examples, the selected smart alarm section 406 is configured to display specific, detailed information about a selected smart alarm (e.g., the smart alarm selected in the triggered smart alarms section 404). The section 406 is configured to display the timestamp and name of the selected smart alarm, as well as a full description of the smart alarm and/or one or more alarms (e.g., alarms 106) and/or events (e.g., events 104) that triggered the smart alarm and/or are otherwise associated with the smart alarm. In some such examples, the full description provides general information about the smart alarm that is based on the type of alarm that was triggered and/or specific information about the smart alarm that is based on the specific instance of the smart alarm. For example, a smart alarm is triggered based on a set of metric values satisfying conditions of the smart alarm and the full description of the smart alarm includes a description of the conditions that are required to trigger the smart alarm and specific metric values that satisfied the conditions in this instance. In an example, the smart alarm is triggered by a bandwidth usage value of 80% or greater and the computing device A has a bandwidth usage value of 87%.

Additionally, the GUI 402 includes user controls 408, 410, and 412. The view alarm details button 408 is configured to enable a user to cause detailed information of the selected smart alarm to be displayed in the selected smart alarm section 406. In some examples, a user is enabled to select a smart alarm displayed in the section 404 and then activate the button 408 which causes the detailed information to be displayed in the section 406. Additionally, or alternatively, the user is enabled to cause detailed information to be displayed in section 406 in other ways (e.g., the information is automatically displayed by selecting the smart alarm in section 404, the information is displayed when the user double-clicks on the selected smart alarm in section 404, or the like).

The mark alarm complete button 410 is configured to enable a user to indicate that the selected smart alarm has been dealt with and/or is otherwise complete. For instance, if a triggered smart alarm requires the user to take some action to remedy an issue in the computing system, the user is enabled to mark the selected smart alarm complete when they have taken that action. In some examples, marking the alarm complete using button 410 causes the completed smart alarm to be removed from the triggered smart alarms section 404. Alternatively, the completed smart alarm is marked with an indicator in the section 404 that indicates that the smart alarm has been dealt with. Additionally, or alternatively, the mark alarm complete button 410 is configured to enable a user to deactivate any active alarms that are associated with the selected smart alarm.

The configure smart alarms button 412 is configured to enable a user to switch to a GUI that is able to configure or otherwise edit the smart alarms of the system (e.g., GUI 502 of FIG. 5 as described below). In some examples, the button 412 is configured to enable a user to reconfigure a smart alarm based on what is selected in the triggered smart alarms section 404 and/or to create, reconfigure, and/or delete any other smart alarm definitions that are associated with the computing system.

FIG. 5 is a diagram 500 illustrating a GUI 502 configured to enable a user to create and/or edit smart alarm definitions. In some examples, the GUI 502 is displayed by or in association with a system such as the system 100 of FIG. 1. The smart alarm configuration GUI 502 includes a smart alarm definitions section 504, a selected smart alarm definition section 506, and user controls 508, 510, and 512.

In some examples, the smart alarm definitions section 504 displays the names of smart alarm definitions that have been defined for the computing system. The section 504 enables a user to select a smart alarm definition to configure using the selected smart alarm definition section 506.

Further, in some examples, the selected smart alarm definition section 506 displays details of the selected smart alarm that can be reconfigured, updated, or otherwise changed by a user of the GUI 502. The section 506 includes a smart alarm name entry, a short description entry (e.g., a short description displayed in section 404 as described above), a full description entry (e.g., a full description displayed in section 406 as described above), and a conditions entry. The conditions entry enables a user to define the conditions that cause the associated smart alarm to be triggered. The defined conditions include alarms being triggered or activated, events occurring, metric values satisfying thresholds and/or ranges, and/or the like. Additionally, the conditions entry enables a user to define how multiple individual conditions are combined to form combined or compound conditions. As illustrated, the entry enables a user to combine multiple conditions using Boolean operators, such that the list of conditions can be logically evaluated as being true or false, wherein a true value of the combined condition indicates that the smart alarm is triggered, and a false value of the combined condition indicates that the smart alarm is not triggered.

In some examples, the create new smart alarm definition button 508 enables a user to create a new smart alarm definition and an associated smart alarm that is then triggered in the associated computing system as described herein. When activated, the button 508 causes the section 506 to have blank entries and enables a user to fill in the entries to define a new smart alarm definition.

Further, the save smart alarm definition button 510 is configured to enable a user to save a smart alarm definition that is currently displayed in section 506, such that the saved smart alarm definition reflects the state of the information currently present in the entries. In examples where a user creates a new smart alarm definition using button 508, after the user has filled out some or all entries of the section 506, the user is enabled to save the newly created smart alarm definition using the button 510.

Additionally, as illustrated, the GUI 502 includes a view triggered smart alarms button 512 that is configured to enable a user to view a GUI that displays the currently triggered smart alarms (e.g., the GUI 402 of FIG. 4 as described herein). It should be understood that, in other examples, the GUI 502 includes more fewer, or different sections and/or user controls without departing from the description.

### Exemplary Operating Environment

The present disclosure is operable with a computing apparatus according to an embodiment as a functional block diagram 600 in FIG. 6. In an example, components of a computing apparatus 618 are implemented as a part of an electronic device according to one or more embodiments described in this specification. The computing apparatus 618 comprises one or more processors 619 which may be microprocessors, controllers, or any other suitable type of processors for processing computer executable instructions to control the operation of the electronic device. Alternatively, or in addition, the processor 619 is any technology capable of executing logic or instructions, such as a hardcoded machine. In some examples, platform software comprising an operating system 620 or any other suitable platform software is provided on the apparatus 618 to enable application software 621 to be executed on the device. In some examples, managing smart alarms and providing associated information as described herein is accomplished by software, hardware, and/or firmware.

In some examples, computer executable instructions are provided using any computer-readable media that are accessible by the computing apparatus 618. Computer-readable media include, for example, computer storage media such as a memory 622 and communications media. Computer storage media, such as a memory 622, include volatile and non-volatile, removable, and non-removable media implemented in any method or technology for storage of information such as computer readable instructions, data structures, program modules or the like. Computer storage media include, but are not limited to, Random Access Memory (RAM), Read-Only Memory (ROM), Erasable Programmable Read-Only Memory (EPROM), Electrically Erasable Programmable Read-Only Memory (EEPROM), persistent memory, phase change memory, flash memory or other memory technology, Compact Disk Read-Only Memory (CD-ROM), digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media do not include communication media. Therefore, a computer storage medium should not be interpreted to be a propagating signal per se. Propagated signals per se are not examples of computer storage media. Although the computer storage medium (the memory 622) is shown within the computing apparatus 618, it will be appreciated by a person skilled in the art, that, in some examples, the storage is distributed or located remotely and accessed via a network or other communication link (e.g., using a communication interface 623).

Further, in some examples, the computing apparatus 618 comprises an input/output controller 624 configured to output information to one or more output devices 625, for example a display or a speaker, which are separate from or integral to the electronic device. Additionally, or alternatively, the input/output controller 624 is configured to receive and process an input from one or more input devices 626, for example, a keyboard, a microphone, or a touchpad. In one example, the output device 625 also acts as the input device. An example of such a device is a touch sensitive display. The input/output controller 624 may also output data to devices other than the output device, e.g., a locally connected printing device. In some examples, a user provides input to the input device(s) 626 and/or receive output from the output device(s) 625.

The functionality described herein can be performed, at least in part, by one or more hardware logic components. According to an embodiment, the computing apparatus 618 is configured by the program code when executed by the processor 619 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, etc.) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that are suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure include different computer-executable instructions or components having more or less functionality than illustrated and described herein.

In examples involving a general-purpose computer, aspects of the disclosure transform the general-purpose computer into a special-purpose computing device when configured to execute the instructions described herein.

An example system comprises: at least one processor; and at least one memory comprising computer program code, the at least one memory and the computer program code configured to, with the at least one processor, cause the at least one processor to: detect at least one alarm associated with at least one event in a computing system; identify a smart alarm definition with which the detected at least one alarm is associated; determine that a condition of the identified smart alarm definition is satisfied at least in part by the at least one alarm; and provide smart alarm information associated with the computing system using the smart alarm definition and the detected at least one alarm.

An example computerized method comprises: detecting, by a processor, at least one alarm associated with at least one event in a computing system; identifying, by the processor, a smart alarm definition with which the detected at least one alarm is associated; determining, by the processor, that a condition of the identified smart alarm definition is satisfied at least in part by the at least one alarm; and providing, by the processor, smart alarm information associated with the computing system using the smart alarm definition and the detected at least one alarm.

One or more computer storage media have computer-executable instructions that, upon execution by a processor, cause the processor to at least: detect at least one alarm associated with at least one event in a computing system; identify a smart alarm definition with which the detected at least one alarm is associated; determine that a condition of the identified smart alarm definition is satisfied at least in part by the at least one alarm; and provide smart alarm information associated with the computing system using the smart alarm definition and the detected at least one alarm.

Alternatively, or in addition to the other examples described herein, examples include any combination of the following:
wherein the at least one alarm includes two alarms that have been triggered by one event of the at least one event; and wherein the identified smart alarm definition is associated with an event type of the one event of the at least one event and the condition of the identified smart alarm definition is satisfied based at least in part on detection of alarm types of the two alarms that have been triggered by the one event.
further comprising: detecting, by the processor, at least one event in the computing system for which no alarm is triggered; wherein identifying the smart alarm definition includes identifying the smart alarm definition with which the detected at least one event is associated; and wherein determining that the condition of the identified smart alarm definition is satisfied includes determining that the condition of the identified smart alarm definition is satisfied at least in part by the at least one event.
wherein determining that the condition of the identified smart alarm definition is satisfied further includes determining that the condition of the identified smart alarm definition is satisfied at least in part based on at least one metric value of the computing system with which the at least one alarm is associated.
wherein the condition of the identified smart alarm definition includes a plurality of sub-conditions, wherein each of the plurality of sub-conditions is evaluated and results of the plurality of sub-conditions being evaluated are combined according to operators of the condition.
wherein providing the smart alarm information associated with the computing system using the smart alarm definition and the detected at least one alarm includes displaying the smart alarm information on a Graphical User Interface (GUI), the displayed smart alarm information including at least one of the following: a name of a smart alarm with which the smart alarm definition is associated; a description of the smart alarm; a timestamp of the smart alarm; and alarm information of the at least one alarm associated with the smart alarm definition.
wherein displaying the smart alarm information on the GUI further includes displaying at least one user control on the GUI, wherein the at least one user control includes at least one of the following: a user control that enables a user to create a new smart alarm definition; a user control that enables a user to edit the smart alarm definition; and a user control that enables a user to delete the smart alarm definition.

Any range or device value given herein may be extended or altered without losing the effect sought, as will be apparent to the skilled person.

Examples have been described with reference to data monitored and/or collected from the users (e.g., user identity data with respect to profiles). In some examples, notice is provided to the users of the collection of the data (e.g., via a dialog box or preference setting) and users are given the opportunity to give or deny consent for the monitoring and/or collection. The consent takes the form of opt-in consent or opt-out consent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The embodiments illustrated and described herein as well as embodiments not specifically described herein but within the scope of aspects of the claims constitute an exemplary means for detecting, by a processor, at least one alarm associated with at least one event in a computing system; exemplary means for identifying, by the processor, a smart alarm definition with which the detected at least one alarm is associated; exemplary means for determining, by the processor, that a condition of the identified smart alarm definition is satisfied at least in part by the at least one alarm; and exemplary means for providing, by the processor, smart alarm information associated with the computing system using the smart alarm definition and the detected at least one alarm.

The term “comprising” is used in this specification to mean including the feature(s) or act(s) followed thereafter, without excluding the presence of one or more additional features or acts.

In some examples, the operations illustrated in the figures are implemented as software instructions encoded on a computer readable medium, in hardware programmed or designed to perform the operations, or both. For example, aspects of the disclosure are implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system comprising:
at least one processor; and
at least one memory comprising computer program code, the at least one memory and the computer program code configured to, with the at least one processor, cause the at least one processor to:
detect at least one alarm in a computing system;
identify a smart alarm definition with which the detected at least one alarm is associated;
determine that a condition of the identified smart alarm definition is satisfied at least in part by the at least one alarm; and
provide smart alarm information associated with the computing system using the smart alarm definition and the detected at least one alarm.

2. The system of claim 1, wherein the at least one alarm includes two alarms that have been triggered by one event; and
wherein the identified smart alarm definition is associated with an event type of the one event and the condition of the identified smart alarm definition is satisfied based at least in part on detection of alarm types of the two alarms that have been triggered by the one event.

3. The system of claim 1, wherein the at least one memory and the computer program code are configured to, with the at least one processor, further cause the at least one processor to:
detect an event in the computing system for which no alarm is triggered;
wherein identifying the smart alarm definition includes identifying the smart alarm definition with which the detected event is associated; and
wherein determining that the condition of the identified smart alarm definition is satisfied includes determining that the condition of the identified smart alarm definition is satisfied at least in part by the event.

4. The system of claim 1, wherein determining that the condition of the identified smart alarm definition is satisfied further includes determining that the condition of the identified smart alarm definition is satisfied at least in part based on at least one metric value of the computing system with which the at least one alarm is associated.

5. The system of claim 1, wherein the condition of the identified smart alarm definition includes a plurality of sub-conditions, wherein each of the plurality of sub-conditions is evaluated and results of the plurality of sub-conditions being evaluated are combined according to operators of the condition.

6. The system of claim 1, wherein providing the smart alarm information associated with the computing system using the smart alarm definition and the detected at least one alarm includes displaying the smart alarm information on a graphical user interface (GUI), the displayed smart alarm information including at least one of the following: a name of a smart alarm with which the smart alarm definition is associated; a description of the smart alarm; a timestamp of the smart alarm; and alarm information of the at least one alarm associated with the smart alarm definition.

7. The system of claim 6, wherein displaying the smart alarm information on the GUI further includes displaying at least one user control on the GUI, wherein the at least one user control includes at least one of the following: a user control that enables a user to create a new smart alarm definition; a user control that enables a user to edit the smart alarm definition; and a user control that enables a user to delete the smart alarm definition.

8. A computerized method comprising:
detecting, by a processor, at least one alarm in a computing system;
identifying, by the processor, a smart alarm definition with which the detected at least one alarm is associated;
determining, by the processor, that a condition of the identified smart alarm definition is satisfied at least in part by the at least one alarm; and
providing, by the processor, smart alarm information associated with the computing system using the smart alarm definition and the detected at least one alarm.

9. The computerized method of claim 8, wherein the at least one alarm includes two alarms that have been triggered by one event; and
wherein the identified smart alarm definition is associated with an event type of the one event and the condition of the identified smart alarm definition is satisfied based at least in part on detection of alarm types of the two alarms that have been triggered by the one event.

10. The computerized method of claim 8, further comprising:
detecting, by the processor, an event in the computing system for which no alarm is triggered;
wherein identifying the smart alarm definition includes identifying the smart alarm definition with which the detected event is associated; and
wherein determining that the condition of the identified smart alarm definition is satisfied includes determining that the condition of the identified smart alarm definition is satisfied at least in part by the event.

11. The computerized method of claim 8, wherein determining that the condition of the identified smart alarm definition is satisfied further includes determining that the condition of the identified smart alarm definition is satisfied at least in part based on at least one metric value of the computing system with which the at least one alarm is associated.

12. The computerized method of claim 8, wherein the condition of the identified smart alarm definition includes a plurality of sub-conditions, wherein each of the plurality of sub-conditions is evaluated and results of the plurality of sub-conditions being evaluated are combined according to operators of the condition.

13. The computerized method of claim 8, wherein providing the smart alarm information associated with the computing system using the smart alarm definition and the detected at least one alarm includes displaying the smart alarm information on a graphical user interface (GUI), the displayed smart alarm information including at least one of the following: a name of a smart alarm with which the smart alarm definition is associated; a description of the smart alarm; a timestamp of the smart alarm; and alarm information of the at least one alarm associated with the smart alarm definition.

14. The computerized method of claim 13, wherein displaying the smart alarm information on the GUI further includes displaying at least one user control on the GUI, wherein the at least one user control includes at least one of the following: a user control that enables a user to create a new smart alarm definition; a user control that enables a user to edit the smart alarm definition; and a user control that enables a user to delete the smart alarm definition.

15. One or more computer storage media having computer-executable instructions that, upon execution by a processor, cause the processor to at least:
detect at least one alarm in a computing system;
identify a smart alarm definition with which the detected at least one alarm is associated;
determine that a condition of the identified smart alarm definition is satisfied at least in part by the at least one alarm; and
provide smart alarm information associated with the computing system using the smart alarm definition and the detected at least one alarm.

16. The one or more computer storage media of claim 15, wherein the at least one alarm includes two alarms that have been triggered by one event; and
wherein the identified smart alarm definition is associated with an event type of the one event and the condition of the identified smart alarm definition is satisfied based at least in part on detection of alarm types of the two alarms that have been triggered by the one event.

17. The one or more computer storage media of claim 15, wherein the computer-executable instructions, upon execution by a processor, further cause the processor to at least:
detect an event in the computing system for which no alarm is triggered;
wherein identifying the smart alarm definition includes identifying the smart alarm definition with which the detected event is associated; and
wherein determining that the condition of the identified smart alarm definition is satisfied includes determining that the condition of the identified smart alarm definition is satisfied at least in part by the event.

18. The one or more computer storage media of claim 15, wherein determining that the condition of the identified smart alarm definition is satisfied further includes determining that the condition of the identified smart alarm definition is satisfied at least in part based on at least one metric value of the computing system with which the at least one alarm is associated.

19. The one or more computer storage media of claim 15, wherein the condition of the identified smart alarm definition includes a plurality of sub-conditions, wherein each of the plurality of sub-conditions is evaluated and results of the plurality of sub-conditions being evaluated are combined according to operators of the condition.

20. The one or more computer storage media of claim 15, wherein providing the smart alarm information associated with the computing system using the smart alarm definition and the detected at least one alarm includes displaying the smart alarm information on a graphical user interface (GUI), the displayed smart alarm information including at least one of the following: a name of a smart alarm with which the smart alarm definition is associated; a description of the smart alarm; a timestamp of the smart alarm; and alarm information of the at least one alarm associated with the smart alarm definition.
